(19) United States
(12) Patent Application Publication
(10) Pub. No.: US 2011/0161813 A1
(43) Pub. Date: Jun. 30, 2011

(54) DATA MEASUREMENT AND FEEDBACK MECHANISM USING AN APPLICATION FRAMEWORK

(75) Inventors: Alan Moskowitz, Oakland, CA (US); Daniel Dennedy, Castro Valley, CA (US); Do H. Chung, San Ramon, CA (US)

(73) Assignee: MOBITV, INC., Emeryville, CA (US)

(21) Appl. No.: 12/651,117

(22) Filed: Dec. 31, 2009

(51) Int. Cl. G06F 3/01

(52) U.S. Cl. 715/716

(57) ABSTRACT

Techniques and apparatuses are provided for conditioning media content based on user input. In one implementation, a barker screen is displayed on an output interface of the user device when a request to switch media channels is received. The barker screen may include a request for user input and at least partially block the output interface. As such, the content of the new channel may be at least partially unavailable until user input is received. Furthermore, techniques and apparatuses are provided for transmitting a request for user input to the user device switched to a unidirectional broadcast channel. Information contained in responses generated based on user inputs is then used to adjust media content.

### BACKGROUND

Data collected from media consumers (e.g., viewers, listeners), especially data collected in real time, is highly desirable but difficult to obtain. Often such data collection requires a separate devices and/or interaction with live operators, which adds complexity to the overall process and tends to discourage viewers from participating. The difficulty of obtaining data is particularly prevalent with unidirectional broadcast media. Further, this complexity slows the process making it difficult to create a real-time interactive environment. Consequently, the techniques and mechanisms of the present invention provide improved mechanisms for collecting user responses that can be used to update media content.

### Overview

Techniques and mechanisms are provided for collecting media consumer responses to confirm media content requested by the consumers and/or to adjust current media content based on the responses. According to particular embodiments, a user device is configured to display a barker screen that blocks at least a portion of its output interface. The barker screen may include a request to provide certain user input, which is then used to generate a response to be sent to a response processing server. In the same or other embodiments, a request for user input is transmitted from the media content switching server through a viewing medium, such as a unidirectional broadcast channel, to a user device. A response generated based on the user input is then received and processed.

Certain aspects of the present invention may be better explained by a way of following examples. Certain media content may be transmitted by a media content switching server using a unidirectional broadcast channel. When a user device attempts to switch to that channel, a barker screen may be first displayed on the user interface of the device. The barker screen may completely or partially block the media content. The barker screen may include a request for user input. In a particular example, the switch to the channel is not performed until user input is provided. Dynamically modified media content corresponding to the unidirectional broadcast channel is presented only after user input is received.

In another example, which may be integrated with the example above, a request is transmitted from a media content switching server to a user device. The user device may be switched to a unidirectional broadcasting channel, which is used for transmission of the request. The request may be configured to display a request screen on the output interface and to collect user input. A response generated based on user input is then received and processed and is used to adjust media content based on information contained in the response.

These and other features of the present invention will be presented in more detail in the following specification of the invention and the accompanying figures, which illustrate by way of example the principles of the invention.

### BRIEF DESCRIPTION OF THE DRAWINGS

The disclosure may best be understood by reference to the following description taken in conjunction with the accompanying drawings, which illustrates particular embodiments of the present invention.

FIG. 1 illustrates a particular example of a network that can be used to implement the techniques and mechanisms of the present invention.

FIG. 2A illustrates a user device displaying a barker screen on the user interface of the device with particular embodiments.

FIG. 2B illustrates a user device displaying media content on the user interface in accordance with particular embodiments.

FIG. 3A illustrates a particular example of a technique for confirming media content based on user input in accordance with certain embodiments.

FIG. 3B illustrates a particular example of a technique for providing user feedback and adjusting media content based on that feedback in accordance with certain embodiments.

FIG. 4 illustrates a particular example of a user device.

FIG. 5 illustrates a particular example of a software stack on a user device.

FIG. 6 illustrates a particular example of a response processing server.

### DESCRIPTION OF PARTICULAR EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of a particular user device, such as a mobile device. However, it should be noted that these techniques and mechanisms can be used with a variety of devices including a general computer system, a mobile device, a cable set-up box, a television, a cell phone, a Person Digital Assistant (PDA), and many others. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a processor is used in a variety of contexts. However, it will be appreciated that multiple processors can also be used while remaining within the scope of the present invention unless otherwise noted. Furthermore, the techniques and mechanisms of the present invention will sometimes describe two entities as being connected. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

The techniques and mechanisms of the present invention recognize that a broadcaster can benefit from confirming media content based on input from media consumers. In this document, media consumers are often referred to as users (e.g., user input). Further, media is often referred to as TV media. However, it should be understood that other forms of media (e.g., radio) are also within the scope of the present invention. User input generally requires some positive action from a user (e.g., pressing an area on a touch screen). However, these techniques and mechanisms may be also used to collect certain information stored on user devices. This process is sometimes referred to as “passive” collection. In certain embodiments, collected information (passive or active) is associated with corresponding media content. For example, a broadcaster may be interested to learn about a typical demographic profile of viewers of a particular program. This information may be used to tailor advertisement materials and/or to decide whether to modify or to discontinue the program.

Conventional media broadcasts (e.g., over the air TV or radio channel) use unidirectional transmission media, which can not be used to receive responses back from media consumers. Further, many conventional receivers have very limited mechanisms available for providing responses to media broadcasters. The techniques and mechanisms of the present invention recognize that media content can be made more interactive and/or more appropriate for the immediate viewing audience by modifying media broadcasts using real-time feedback. For example, responses and user information can be used to customize programming, tailor advertising content, create target product promotions, revise content streams, and recommend additional content even during conventional media broadcasts. Furthermore, user devices can also be used to supply additional information about the viewers and their respective devices.

Certain user devices provide a unique opportunity to implement techniques and mechanisms described herein due to their abilities to receive and process unidirectional broadcast signal from broadcasting transmitters and provide two-way communication over other wired or wireless networks, such as cellular networks. Therefore, even when media content is provided over conventional media broadcasts, a different communication modality could be used to send a response. More specifically, such user devices allow integrating multiple communication modalities while providing a unified user experience. Yet, in certain embodiments, media content is provided through a bi-directional network, such as the Internet. In these embodiments, both media content and user responses may be transmitted through the same network or communication medium. For example, Internet TV broadcast and user responses can be both transmitted to a mobile phone through a cellular network (e.g., a 3G network). In particular embodiments, a media content switching server could also be used as a response processing server. In other words, a user device may communicate with the same server both to receive media content and to provide a response.

According to various embodiments, a user device is connected to a response processing server through a cellular network, such as a 3G network. Examples of cellular networks include, but not limited to TDMA Single-Carrier, CDMA Multi-Carrier, CDMA Direct Spread, CDMA TDD, FDMA/TDMA, and IP-OFDMA. Cellular networks may be supported by different cell phone providers. In a specific example, at least two of the cellular networks that are used to collect user responses are supported by different cellular network providers. More generally, any network that allows two-way wired and/or wireless transmission to user devices may be used for collecting user responses, such as Wi-Fi, Muni Wi-Fi, General packet radio service (GPRS), iBurst, WiBro/WiMAX, Universal Mobile Telecommunications System-Time-Division Duplexing (UMTS-TDD), High Speed Packet Access (HSPA), Evolution-Data Optimized (EVDO), Long Term Evolution (LTE), satellite, and many others. As noted above, a user device may receive media content from a media content switching server using one of the networks and technologies described above.

A viewing medium is used for transmitting media content, such as video, audio, text, and other forms of data. In certain embodiments, a viewing medium is a unidirectional broadcast, and media content is presented on a particular unidirectional broadcast channel. A user switches to a channel to access corresponding media content. A channel switching process is sometimes referred to as tuning to a channel. In particular embodiments, the viewing medium is based on a mobile digital TV transmission protocol and technologies, such as Advanced Television Systems Committee-Mobile/Handheld (ATSC-M/H) protocol, Terrestrial Digital Multimedia Broadcasting (T-DMB), Digital Video Broadcasting-Handheld (DVB-H), etc.

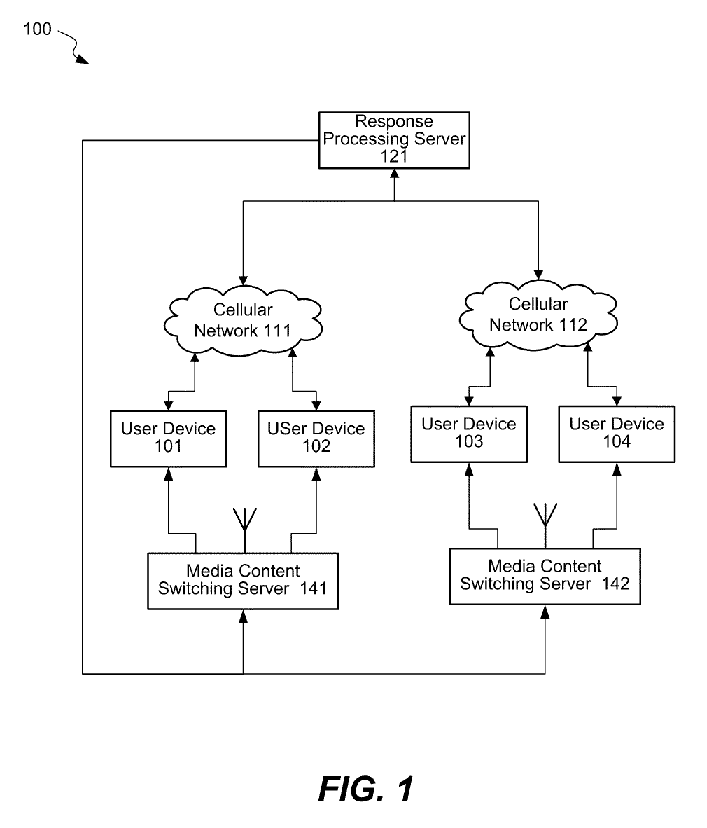

FIG. 1 is a diagrammatic representation showing one example of an overall network system 100 that can be used to implement various embodiments of techniques and apparatuses described below. As illustrated, the system 100 may include one or more wired or wireless bidirectional communication networks (e.g., cellular networks 111 and 112), computer networks, unidirectional media broadcasting networks (e.g., provided by media broadcast switches 141 and 142), and other types of communication networks. It should be noted that some of the illustrated networks and elements may be not present in particular embodiments. Generally, only one communications medium that allows transmitting media content to a user device and receiving a response from the user device is needed. In some embodiments, media content transmission is performed over one communications medium (e.g., unidirectional broadcast from a media content switching server), while response is transmitted over another communications medium (e.g., a bidirectional network, such as cellular network).

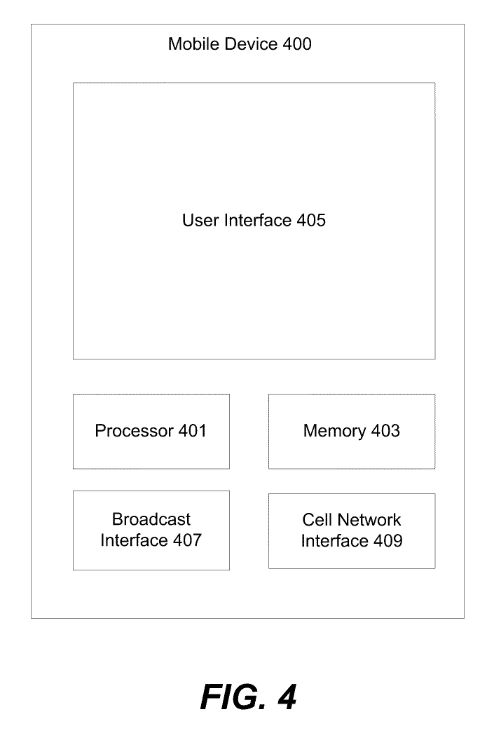

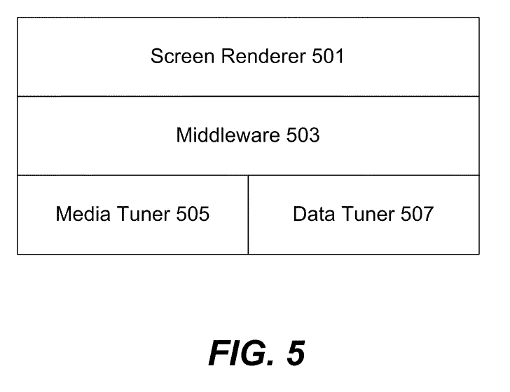

According to particular embodiments, the system 100 includes one or more user devices 101-104 that are configured to receive and display media content, to receive user input, and to transmit a response based on user input. These functions can be performed using one or more communications media described above. Examples of user devices include various mobile devices, such as cell phones, smart-phones, personal digital assistants (PDA), media players, as well as personal computers, servers, TV set-up boxes, and other devices. Certain hardware aspects of a user device are described in the context of FIG. 4. Software aspects are further covered in the context of FIG. 5.

In particular embodiments, a user device is configured to receive unidirectional media broadcast signals, such as TV and/or radio transmission signals, from one or more media content switching servers 141-142 These signals may include real-time audio and video streams, individual, non-real-time video and audio streams, etc. For the purposes of this document, a media content switching server may be any device that is used to deliver media content to one or more user devices 101-104. Examples of media content switching servers include a transmitter, repeater, gap-filler, and satellite. The media content switching servers 141-142 may use various technologies and protocols, listed above, to deliver the signal to the user devices 101-104.

According to particular embodiments, a broadcasting service (e.g., a TV or radio station) intially prepares media content that is converted into radio frequency signals by the media content switching servers 141-142 and that is transmitted to the user devices 101-104. The user devices 101-104 are configured to decode the received radio signals and to display media content corresponding to one or more channels on their user interfaces. The broadcasting service typically has content provider links as well as a content database (not shown).

In some embodiments, a response processing server 121 provides feedback to the media content switching servers 141-142. This feedback may be used for real-time adjustments of the media content or some future operations. For example, a broadcaster may collect certain data contained in such feedbacks over a period of time and use this data for statistical analysis and other purposes. The response processing server 121 may be operated by an entity (e.g., a service provider) that is different from a broadcaster. For example, one response processing server may be used to provide feedback to multiple broadcasters. In other embodiments, a response processing server 121 and a media content switching server 141 may be integrated into a single server. Such server may be used both to provide media content and to receive responses from user devices connected with bidirectional communications mechanisms.

According to particular embodiments, user devices 101-104 are configured to deliver responses to the response processing server 121 over wired and/or wireless bidirectional communication networks, such as cellular networks 111-112. An IP address or some other identifier of the response processing server 121 may be stored in the memory of the user device or transmitted together with a request. For example, a broadcaster may have its own designated response processing server. When a user switches to a media channel provided by this broadcaster and the broadcaster sends a request to the user, the request may include an IP address to transmit a response to that server.

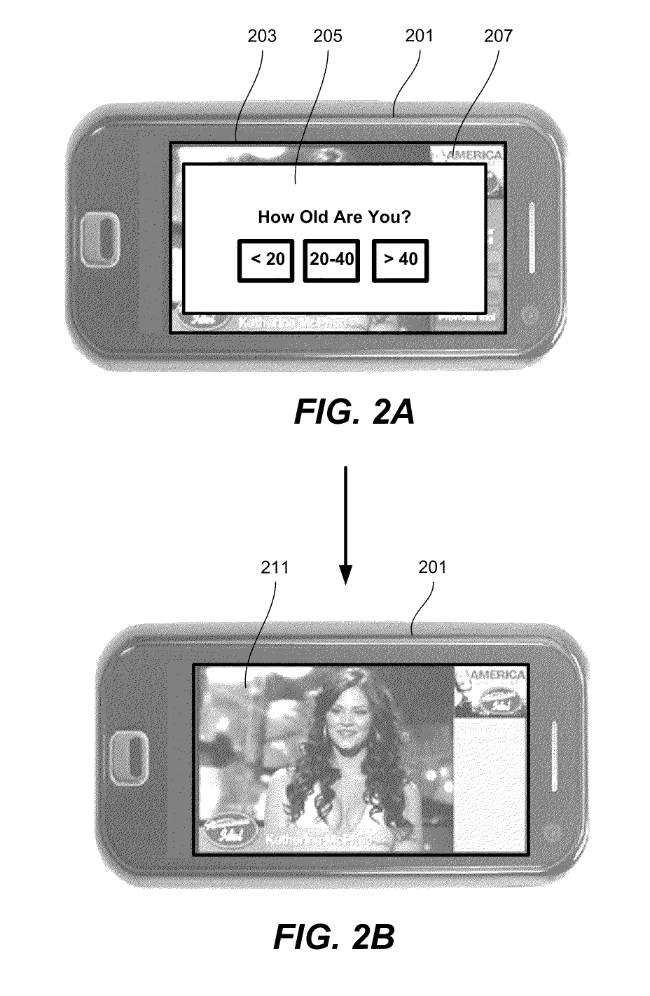

FIG. 2A illustrates a user device 201 with a output interface 203 displaying a portion of the media content 207 and a barker screen 205 in accordance with certain embodiments. An output interface may be a screen, display, projector, speaker, or any other output devices. Sometimes an output interface is also referred to as a user interface. However, it should be understood that a user interface can also include other interfaces, such as an input interface. As shown, the barker screen 205 blocks a portion of the output interface 203 and prevents a user from fully viewing or otherwise experiencing the media content 207. The barker screen 205 may contain a request for user input. In particular embodiments, the barker screen 205 asks a user to input demographic and profile information. Further, once a user provides all requested input on one barker screen, another barker screen may be displayed on the output interface. The process may repeat until all requested information is provided by the user. In particular embodiments, a barker screen may also be displayed on the output interface while no input is requested from the user. For example, a barker screen may be displayed while the response is transmitted to the response processing server, processed by the server, and until a reply authorizing the user device to remove the barker screen is received by the user device.

At some point, the user interface may start displaying unobstructed media content 211 as shown in FIG. 2B. A triggering event may be receiving user input, receiving a reply from the response processing server, a timeout period, switching to another channel, or any other suitable triggering event.

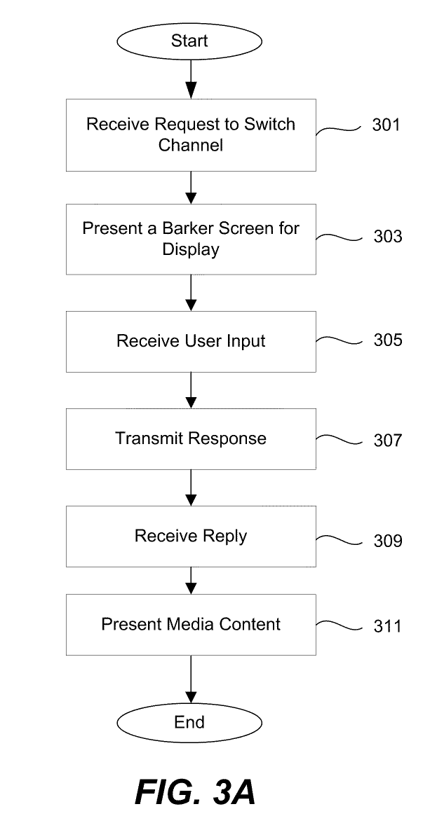

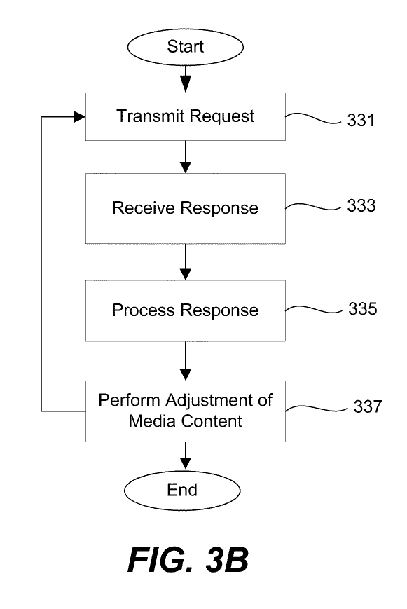

FIG. 3A illustrates one example of a technique for confirming media content based on user input in accordance with certain embodiments. At 301, a user device receives a request to switch the device from the first media channel to a second media channel. In some situations, this may involve initial switching to a particular media channel, e.g., when no prior channel exists. A user device may include software providing channel options on the user interface and a mechanism for selecting an option. Once the request to switch to a new channel is received, the user device performs functions associated with receiving and displaying media content on the user interface. These functions may involve decoding a received broadcasting signal so that selected media content is displayed.

A barker screen may be then presented for display on at least a portion the output interface (block 303). One such example is illustrated in FIG. 2A. In certain embodiments, no media content is displayed on the output interface in operation 303. For example, when a user requests switching to a new channel, the user device may be configured to switch first to a corresponding barker channel. In other embodiments, an output interface may display at least a portion of the media content, but the barker screen obstructs viewing of this content. As mentioned above, the barker screen typically includes a request for user input. Providing input may involve displaying a sequence of different barker screens (e.g., asking for additional information). In certain embodiments, the information is collected passively (e.g., from user device's memory) and no user input is needed. A barker screen may still be used to obstruct media content until, for example, a reply from the response processing server is received by the user device.

A device may then receive user input (block 305) that responds to a request displayed on the barker screen. A user device may have one or more input interfaces. It should be noted that a period of user inaction or a channel change event may also be considered as user input. In some embodiments, the operation 305 is not performed. For example, a request may include “passive collection” of information from the user device as described above.

Once the input is provided and/or data collected from the user device, the device may transmit a response to the response processing server (block 307). As described in the context of FIG. 1, a response may be transmitted using any bidirectional communication medium. The response may include user input as well as user demographic information, user profile information, user preferences, device characteristics, device specifications, usage characteristics, etc. It should be noted that an order of the operations in illustrated in the FIG. 3A flowchart could be different. For example, media content may be displayed (block 311) before the response is transmitted (block 307) and be based on some triggering event described above.

After transmitting the response, the user device may receive a reply (block 309). A reply may be transmitted from the response processing server or from the media content switching server. In certain embodiments, a reply may include instructions to the user device for switching to a channel containing actual media content (e.g., switching from a barker channel to a media content channel). In particular embodiments, the response includes other channel suggestions, advertisement materials, and/or other instructions. It should be noted that receiving a reply (block 309) is an optional operation. A user device may proceed with displaying a media content based on the other triggering events as described below without receiving any replies.

At some point, a triggering event occurs resulting in media content displayed on the user interface (block 311). A triggering event may be completion of all requested user inputs, receipt of a response (operation 309), time out period, information contained in the user input or stored on the user device.

FIG. 3B illustrates a particular example of a technique for providing user feedback and adjusting media content based on that feedback in accordance with certain embodiments. This technique may be used in combination with or independently fro m the technique described above in the context of FIG. 3A. Further, certain features described in the context of one flow chart could be used in a technique described by another flowchart.

The technique may start with transmission of a request for user input to one or more user devices (block 331). In certain embodiments, a request is transmitted through a viewing medium. For example, a user device may be tuned to a particular media channel, and a request is transmitted as a part of the overall media content. In other embodiments, a request is transmitted through another medium (e.g., a bidirectional communication medium). In a particular example, a response processing server has information about user devices tuned to a particular channel. The server uses this information to transmit a request to these devices. A request may include instructions for user devices to display a request screen, which may be similar to a barker screen described above.

Once one or more users respond to the request, their user devices generate responses based on user inputs and transmit these responses to a response processing server. In addition to inputs provided by users, responses may include information stored and collected by the user devices (e.g., viewing profile, device characteristics, user location, user profile, etc.).

The responses are received by one or more response processing servers (block 333). As mentioned above, a request may include an address (e.g., an IP address) of a response processing server. In some examples, a user may transmit one response to one processing server and another response to another processing server. Further, the user device may transmit the same response to multiple servers. For example, a broadcaster, marketing entity, cellular phone service provider, and other entities may be interested in all or parts of information contained in the responses.

In certain embodiments, a response processing server waits for a predetermined period of time while receiving responses in operations 333. A request may provide some time for users to respond. Further, a period of time may be allocated for response transmission.

Received responses are then processed by a response processing server (block 335). Processing may be performed upon receiving each new response, upon receiving a predetermined number of the responses, after a predetermined period of time, or according to any other process initialization scheme. Often, the server processes responses in multiple batches in order to provide intermediate results to interested parties. For example, the broadcasting service may receive intermediate result and update the broadcast content with the “up-to-date” results while additional responses are being collected and processed by the server. Such scheme (i.e., broadcasting intermediate results) may encourage additional viewers to respond. Processing of the responses (block 335) may involve integrating responses from multiple users and, in certain embodiments, performing statistical analysis of the received data. (e.g., calculating averages, standard deviations, etc). Processing responses may involve updating a media channel dashboard, for example to display a total number of viewers, a number of viewers who responded to the request, information contained in the responses, correlations to the current media content, etc.

The results of operation 335 may be used to perform adjustments of media content (block 337), for example, to introduce media content more appropriate to the viewer profile indentified from the responses. In a particular example, responses may reveal that the respondents belong to a particular demographic category identified by the broadcaster. The broadcaster may use this information to introduce advertisement content specific to this demographic category. In general, viewer feedback may be used to improve viewer experience and/or maximize advertising effectiveness.

Further, certain data contained in responses may be collected over a period of time and may be stored on a response processing server and/or on a media content switching server. For example, a broadcaster may need to know how a particular show performs throughout the season and use this information to adjust its advertising practices (e.g., cost, content, duration, etc.). If data is stored on a response processing server by an entity other than the broadcaster, it may be delivered to or retrieved by a broadcaster for a certain fee.

In certain embodiments, response results from operation 335 are used to adjust media content in order to maximize a number of viewers belonging to a specific profile. For example, a broadcaster may be interested in presenting media content that would be more appropriate to a particular demographic group. Yet, the broadcaster may learn from the user responses that very few viewers belong to that group. The broadcaster may start integrating messages about upcoming media content in order to attract new viewers and retain existing viewers belonging to the target demographic group.

Certain operations of the technique illustrated in FIG. 3B may be repeated. For example, a broadcaster may adjust media content and later transmit another request to measure effectiveness of this adjustment. Sometimes a request does not require any input from users and may only collect data stored on user devices. For example, a number of viewers (e.g., a number of users tuned to a particular channel for a predetermined period of time) may be periodically measured and correlated to media content and/or other parameters (e.g., day of the week, time of the day). In certain embodiments, a series of operations for collecting responses may be repeated before any media content is adjusted.

FIG. 4 illustrates a particular example of a user device 400. The user device 400 includes a processor 401, a memory 403, a user interface 405, a broadcast interface 407, a cellular network interface 409, and a power source 411. The broadcast interface 407 may receive unidirectional media broadcasts transmitted using a variety of modalities such as over the air broadcasts, packet based unidirectional broadcasts, tower based unidirectional broadcasts, etc. Unlike conventional cell phones, user devices that are used to implement various embodiments of techniques and mechanisms described in this document have special capabilities associated with receiving and processing broadcast signals, communicating information to servers, and perform other functions. For example, a processor 401 may be configured to provide high definition TV resolution on the user interface 405. An example of such processor is a DMS-02 chip available from 3DLabs in Milpitas, CA that is capable of 720 pixels resolution AVC/H.264 video playback. A user interface 405, such as an LCD screen, may be configured to support the translated content (e.g., an adequate screen resolution). The memory 403 may need to support the high buffer requirements of mobile TV, particularly in HDTV mode, as well as advanced software application for processing broadcast signals. Furthermore, advanced processing, communicating, and displaying capabilities of these user devices and more frequent use of these capabilities require substantial power outputs provided by the power source 411.

FIG. 5 illustrates one example of a software architecture stack, which can be implemented on the user devices described above. In particular embodiments, a media tuner 505 and a data tuner 507 may be used. A media tuner 505 is used to process media data provided in the unidirectional broadcasted signal. The media tuner 505 decodes the signal to retrieve media data corresponding to a particular channel to which the user device is currently tuned to. A data tuner 507 is used to process bi-directional data stream, e.g., a cellular network communication signal. A middleware layer 503 may be positioned between a screen rendered 501 and the media tuner 505 and the data tuner 507. The middleware 503 is used to integrate unidirectional broadcasted signals processed by the media tuner 505 with bi-directional data streams processed by the data tuner 507 to provide inputs to the user interface of the user devices and process various outputs. Such integration may involve processing and displaying inputs of the two communication streams, processing outputs provided by a user on the user interface, and directing information corresponding to these outputs to the data tuner 507, and other functions. For example, a media tuner 505 may receive a signal containing a request as well as other media content. A media tuner 505 processes the signal and passes it to the middleware 503. The middleware 503 then instructs the screen render 501 when and whether to display information contained in the request (e.g., a survey) based on inputs provided by the user (e.g., channel selection, using other functions of the user devices). Once the information contained in the request is displayed and the user response is received, the middleware 503 processes the response and instructs the data tuner 507 to send information corresponding to the response to a designated recipient (e.g., a response processing server).

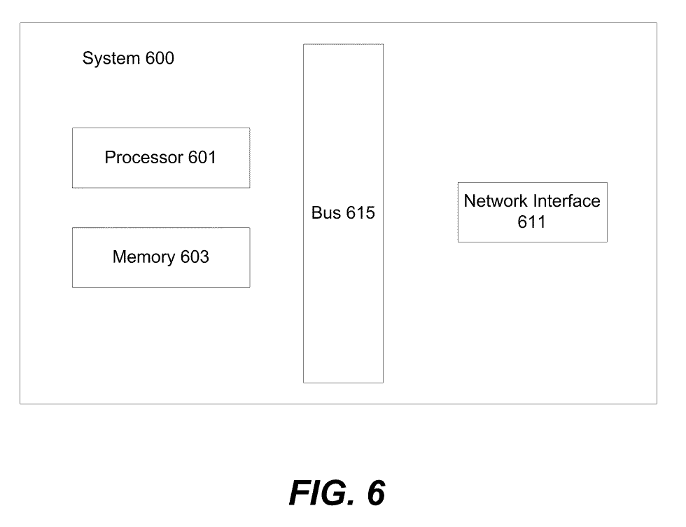

FIG. 6 illustrates one example of a response processing server. According to particular embodiments, the server 600 suitable for various embodiments of techniques and mechanisms described in this document includes a processor 601, a memory 603, an interface 611, and a bus 615 (e.g., a PCI bus or other interconnection fabric) and operates as a streaming server. When acting under the control of appropriate software or firmware, the processor 601 is responsible for collecting and processing user response and generating and transmitting reports based on these responses. In some embodiments, this server may also be used to generate and adjust media content based on user responses. Various specially configured devices can also be used in place of a processor 601 or in addition to processor 601. The interface 611 is typically configured to end and receive data packets or data segments over a network.

Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

While the invention has been particularly shown and described with reference to specific embodiments thereof, it will be understood by those skilled in the art that changes in the form and details of the disclosed embodiments may be made without departing from the spirit or scope of the invention. It is therefore intended that the invention be interpreted to include all variations and equivalents that fall within the true spirit and scope of the present invention.

What is claimed is:

1. A method comprising:
receiving a request to switch a user device from a first media channel to a second media channel, wherein the second media channel is a unidirectional broadcast channel;
presenting a barker screen for display on an output interface associated with the user device, the barker screen including a request for user input and blocking at least a portion of the output interface, wherein the barker screen is triggered by the switch from the first media channel to the second media channel;
receiving user input in response to the request for user input; and
presenting dynamically modified media content associated with the second media channel.

2. The method of claim 1, wherein the baker screen is displayed immediately after receiving the request to switch to the second media channel.

3. The method of claim 1, further comprising transmitting to a response processing server a response generated based on the user input.

4. The method of claim 3, further comprising, after transmitting the response, receiving a reply comprising instructions for presenting the dynamically modified media content.

5. The method of claim 3, wherein transmitting the response is performed through a bi-directional network.

6. The method of claim 1, wherein the user device is configured to present the barker screen based on instructions stored in a memory of the user device.

7. The method of claim 1, wherein the dynamically modified media content is at least partially blocked based on information contained in the user input.

8. The method of claim 1, wherein the user device is a device selected from the group consisting of a mobile phone, a Personal Digital Assistant (a PDA), a television set, a cable set-up box, and a computer system.

9. An apparatus comprising:
an input interface operable to receive a request to switch the apparatus from a first media channel to a second media channel and operable to receive user input in response to the request, wherein the second media channel is a unidirectional broadcast channel; and
an output interface operable to present a barker screen for display on the output interface and operable to present dynamically modified media content associated with the second media channel, wherein the barker screen includes a request for user input and blocking at least a portion of the output interface and wherein the barker screen is triggered by the switch from the first media channel to the second media channel.

10. A user device, comprising:
means for receiving a request to switch the user device from a first media channel to a second media channel, wherein the second media channel is a unidirectional broadcast channel;
means for presenting a barker screen for display on an output interface associated with the user device, the barker screen including a request for user input and blocking at least a portion of the output interface, wherein the barker screen is triggered by the switch from the first media channel to the second media channel;
means for receiving user input in response to the request for user input; and
means for presenting dynamically modified media content associated with the second media channel.

11. A method comprising:
transmitting a request through a unidirectional broadcast channel to a user device switched to the unidirectional broadcast channel, wherein the request is configured to display a request screen on an output interface of the user device and collect user input;
receiving a response from the user device generated based on the user input;
processing the response received from the user device; and
performing an adjustment of the media content based on information contained in the response.

12. The method of claim 11 further comprising receiving a second response and performing a second adjustment of the media content based on information contained in the second response.

13. The method of claim 11, wherein the response comprises a measure of user opinion about the media content.

14. The method of claim 11, wherein the response comprises a user demographic profile.

15. The method of claim 11, wherein the response comprises duration of being switched to the unidirectional broadcast channel.

16. The method of claim 11, wherein the user device is configured to automatically transmit responses after each predetermined time interval.

17. The method of claim 11, wherein the request contains instruction for the user device to at least partially block the media content on an output interface of the user device until the user input is collected.

18. The method of claim 11, wherein the adjustment of the media content is performed after receiving multiple responses over a predetermined period of time.

19. An apparatus comprising:
an output interface operable to transmit a request through a unidirectional broadcast channel to a user device switched to the unidirectional broadcast channel, wherein the request is configured to display a request screen on the user device and collect user input;
an input interface operable to receive a response from the user device generated based on the user input; and
a processor operable to process the response received from the user device and perform an adjustment of the media content based on information contained in the response.

20. A device comprising:
means for transmitting a request through a unidirectional broadcast channel to a user device switched to the unidirectional broadcast channel, wherein the request is configured to display a request screen on an output interface of the user device and collect user input;
means for receiving a response from the user device generated based on the user input;
means for processing the response received from the user device; and
means for performing an adjustment of the media content based on information contained in the response.
